(19) United States
(12) Patent Application Publication
(10) Pub. No.: US 2019/0327127 A1
(43) Pub. Date: Oct. 24, 2019

(54) INFORMATION TECHNOLOGY EVENT MANAGEMENT

(71) Applicant: ENTIT Software LLC, Sunnyvale, CA (US)

(72) Inventors: Stefan Bergstein, Boeblingen (DE); Nisa Bozkurt, Boeblingen (DE)

(21) Appl. No.: 15/960,047

(22) Filed: Apr. 23, 2018

(51) Int. Cl. H04L 12/24

(52) U.S. Cl. CPC H04L 41/069; G06N 99/005; H04L 41/0654; H04L 41/22

(57) ABSTRACT

An event management system is monitored for incoming information technology events. Responsive to detecting that the system has received a new event, if the new event is encompassed by any previously created event cluster, the system is instructed to refrain from presenting the new event to a user for handling. If the new event is not encompassed by any previously created event cluster, the system is instructed to present the new event to the user for handling. If the user then performs an ignore or dismiss action in relation to the new event, whether the new event is similar to other events in relation to which the user performed the ignore or dismiss action is determined. If the new event is similar to these other events, a new event cluster against which subsequently received events are compared is created.

### BACKGROUND

Organizations, such as enterprises, can have a diverse and abundant information technology (IT) infrastructure. The IT infrastructure can include different types of computing resources, or assets, distributed among data centers, private cloud deployments, and public cloud facilities situated in different geographical areas. IT operations management is the process of managing the provisioning, capacity, performance, and availability of this infrastructure.

### BRIEF DESCRIPTION OF THE DRAWINGS

FIG. 1 is a diagram of an example system including event presentation reduction logic for an event management system that receives information technology (IT) events from an IT infrastructure.

FIG. 2 is a flowchart of an example method for detecting a pre-noise IT event.

FIG. 3 is a flowchart of an example method for creating and maintaining noise IT event clusters.

FIG. 4 is a flowchart of an example method for controlling presentation of an IT event by an event management system based on whether the event is an IT noise event.

FIG. 5 is a flowchart of a method for reducing the presentation of received events by an event management system.

FIG. 6 is a diagram of a storage medium storing instructions that when executed by a processor reduce the presentation of received events by an event management system.

FIG. 7 is a block diagram of a system that reduces the presentation of received events by an event management system.

### DETAILED DESCRIPTION

As noted in the background section, information technology (IT) operations management involves managing an IT infrastructure of an enterprise. The computing resources, or assets, of the IT infrastructure can asynchronously or synchronously generate events that an event management system collects for presentation to a user, such as an operator, for handling. The vast majority of the generated events may be informational in nature or otherwise not require the immediate attention of the user. However, the small number of events to which the operator should immediately attend can become obfuscated by the “noise” of the other events.

Techniques described herein provide for an adaptive, learning manner by which events that do not require immediate user attention for resolution are distinguished from events that do. The former events may be referred to as noise events, for instance. When an event management system receives a new event, event presentation reduction logic can determine whether the event is a noise event or not. If the new event is the former, the logic may instruct the event management system to suppress presentation of the event to the user. If the new event is not a noise event, the logic may instruct the system to present the event. In this way, the user is less likely to become overwhelmed by noise events, and thus less likely to miss an event to which the user should attend.

In one implementation, the techniques described herein can adaptively learn which events are noise events and which events are not by observing user behavior as the event management system receives events. If a user ignores or dismisses an event, the event can be considered a pre-noise event—that is, a noise event candidate. If the event is sufficiently similar to other, previously received pre-noise events, a noise event cluster may be spawned. Thereafter, when the event management system receives a new event, if any noise event cluster encompasses the event, then the new event is considered a noise event and not presented to the user.

The techniques described herein thus improve the capabilities of a computing system, by more efficiently identifying events that represent anomalous behavior of IT infrastructure. Such events can include software running on the computing system performing inefficiently, or malfunctioning such that the software is not performing its requisite functionality at all. Other events that can be identified include performance issues that result from improper configuration of software and/or hardware, or that result from changes in the usage of the system causing the system as currently configured now being suboptimal. Still other events can include hardware errors, including the malfunctioning of hardware components of the system.

By providing for the identification of these and other events more efficiently, the techniques described herein therefore permit the IT infrastructure to operate more efficiently and otherwise perform better. Furthermore, the techniques can include performing a remediation action to resolve an issue underlying an identified event. For example, software and/or hardware may be automatically reconfigured to resolve the issue that resulted in an event. The identification of the event therefore permits the issue to be resolved. Insofar as the identified event is not presented to the user, the remediation action is performed without any user interaction, resulting in the issue that caused the event to be more quickly and thus more efficiently resolved than if the computing system had to wait for the user.

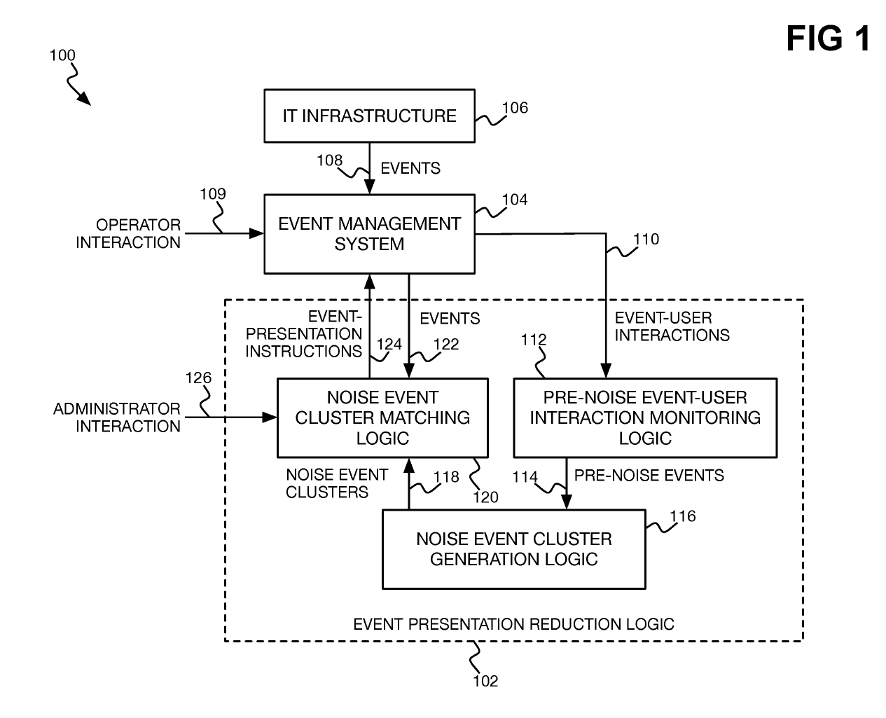

FIG. 1 shows an example system including event presentation reduction logic 102, an event management system 104, and an IT infrastructure 106. The IT infrastructure 106 can include managed IT components, or resources, including hardware and software resources. The IT infrastructure 106 of an enterprise may encompass those resources that provide for the computing functionality of the enterprise, including data storage and manipulation, and so on. The managed IT components of the IT infrastructure 106 may asynchronously or synchronously generate IT events 108, on which basis the IT infrastructure 106 can be monitored and thus managed.

The event management system 104 can be a centralized system that collects the IT events 108 generated by the IT infrastructure 106 for review by an operator or other user. The event management system 104 may be a preexisting such system that may have open functionality permitting the event presentation reduction logic 102 to interact therewith. As the event management system 104 receives the events 108, the system 104 may present them to the operator for review. As one example, the system 104 may display a graphical user interface (GUI) dialog window to the operator, identifying an event 108, and permitting the user to select an option to perform an action related to the event, including to review further information regarding the event, or to dismiss the event. As another example, multiple events 108 may be displayed within a list to the operator.

When the user, such as the operator, proceeds to dismiss an event, the event management system 104 may continue storing the event within a log, which the user may later recall to review the event. However, at the time of dismissal, the system 104 may not otherwise perform any other action regarding the event, such as an action intended to resolve the underlying condition at a managed IT infrastructure resource that resulted in generation of the event. The user may also just ignore the event as displayed.

Pre-noise event-user interaction monitoring logic 102 monitors such event-user interactions 110. The pre-noise event-user interaction monitoring logic 112 is a part of the event presentation reduction logic 102, as are noise event cluster generation logic 116 and noise event cluster matching logic 120. The reduction logic 102, including its constituent logic 112, 116, and 120, can be implemented at least in hardware. For instance, the logic 102 may be implemented by a processor of a computing device including a processor and memory or another type of non-transitory computer-readable data storage medium. The memory or other medium stores instructions (e.g., program code) that the processor logic performs to realize the functionality ascribed to the logic 102 (including its constituent logic 112, 116, and 120) herein.

The pre-noise event-user interaction monitoring logic 102 monitors user, such as operator, interactions 110 with events that may be pre-noise events. Such events are pre-noise events in that they have not been classified or determined to be noise events to which the user does not have to immediately attend. The interaction monitoring logic 112 specifically monitors the operator interaction 109 with events 108 that the event management system 104 has displayed, as the event-user interactions 110, for dismissal or ignoring by the user. That is, the logic 112 monitors the event-user interactions 110 for performance of ignore or dismiss actions by the user in relation to the events.

For instance, when an event arrives at the event management system 104, the system 104 can present the event to the operator or other user.

The same event management system 104, or another event management system, may also present the event to one or more different operators or users. One of the operators can “own” the event, by performing an ownership action that indicates that the operator in question takes ownership of the issue that caused the event (and thus may attempt to solve the underlying issue).

Therefore, when an event arrives, an operator can initially perform one of two actions. First, the operator can close, or dismiss, the event, without having taken ownership of the event (i.e., without having performed the ownership action prior to closing the event). Therefore, what is referred to herein as an ignore or dismiss action can include an operator closing the event without having performed the ownership action first. The logic 112 monitors the event-user interactions 110 for performance of such a dismiss action.

Second, the operator may instead take ownership of the event, via performance of an ownership action. Once the operator “owns” the event, the operator may immediately (i.e., within a specified threshold of time) close, or dismiss, the event, without having in the interim taken any other action in an attempt, for instance, to resolve the underlying issue. As such, the operator effectively ignores the event, even though the operator has taken ownership of the event. Therefore, what is referred to herein as an ignore or dismiss action can also include an operator closing the event within a threshold period of time after having performed the ownership action, and when the operator has not performed any other action in relation to the event between owning the event and closing the event. The logic 112 monitors the event user interactions 110 for performance of such an ignore action.

When the pre-noise event-user interaction monitoring logic 112 has detected an event-user interaction 110 concerning an event in relation to which the operator or other user has performed such a dismissal or ignore action, the monitoring logic 112 passes the event as a pre-noise event 114 to the noise event cluster generation logic 116. That is, an event in relation to which a dismissal or ignore action has been performed is considered a pre-noise event. A pre-noise event is an event that may be used to subsequently identify noise events, if a sufficient number of similar pre-noise events 114 are passed by the monitoring logic 102 to the cluster generation logic 116 to warrant generation of a noise event cluster.

Therefore, the noise event cluster generation logic 116 maintains the pre-noise events 114 that the pre-noise event-user interaction monitoring logic 112 outputs. When a new pre-noise event 114 is received, the noise event cluster generation logic 116 determines if it has now received more than a threshold number of similar pre-noise events to warrant generation of a new noise event cluster. The generation logic 116 correspondingly generates a cluster for a new noise event, where the new noise event encompasses these similar pre-noise events. The pre-noise events are now effectively noise events, because a noise event cluster has been created that encompasses them. The generation logic 116 provides newly generated noise event clusters 118 to the noise event cluster matching logic 120.

The noise event cluster matching logic 120 receives events 122 from the event management system 104 as the system 104 receives them from the IT infrastructure 106. For each event 122, the noise event cluster matching logic 120 determines whether any noise event cluster 118 received from the noise event cluster generation logic 116 encompasses the event 122—i.e., whether the newly received event 122 matches any existing noise event cluster 118. If there is such a match, then the matching logic 120 provides an event-presentation instruction 124 to the event management system 104 to refrain from presenting the event 122 to the operator or other user. For example, the system 104 may log the event 122 without first presenting the event 122 to the user within a GUI dialog window.

By comparison, if the noise event cluster matching logic 120 determines that none of the noise event clusters 118 encompass a newly received event 122, then the matching logic 120 may provide an event-presentation instruction 124 to the event management system 104 to present the event 122 to the user. In this case, the system 104 may correspondingly present the event 122 to the user within a GUI dialog window. Thereafter, an operator interaction 109 may occur, which the pre-noise event-user interaction monitoring logic 112 monitors as an event-user interaction 110 as has been described.

In this way, the event presentation reduction logic 102 reduces the number of events that the event management system 104 presents to the operator or other user. The reduction logic 102 classifies newly received events as noise events when they match existing noise event clusters, and correspondingly instructs the system 104 not to display such events. As to newly received events that are not classified as noise events, the system 104 displays such events to the user, as instructed by the reduction logic 102, and the logic 102 then monitors how the operator or other user interacts with these events. When the user performs dismissal or ignore actions in relation to such displayed events, the reduction logic 102 classifies the events as pre-noise events, which may then be promoted to noise events when there are a sufficient number to warrant creation of a corresponding noise event cluster.

There may further be interaction 126 by a different user, such as an administrator other than an operator, with respect to the noise event cluster matching logic 120. This interaction 126 can include maintenance of the noise event clusters that the noise event cluster generation logic 116 has generated and provided to the matching logic 120. For example, the administrator may manually delete noise event clusters that have been created. Tuning an existing noise event cluster can include definitionally adjusting the cluster, to influence whether or how a newly received event will match the cluster.

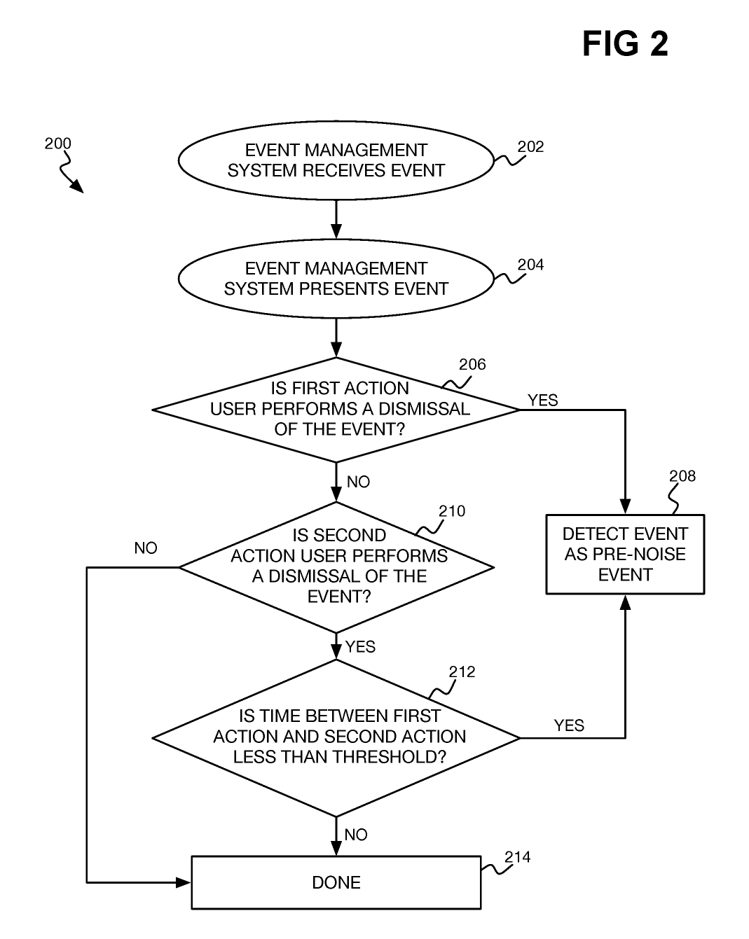

FIG. 2 shows an example method 200 for detecting a pre-noise event. That is, the method 200 determines that in relation to a received event, a user like an operator has performed an ignore or dismiss action. The pre-noise event-user interaction monitoring logic 112 can perform the method 200, in conjunction with functionality that the event management system 104 performs, via the monitoring logic 112 monitoring the event management system 104 as the system 104 receives an event and as a user interacts with the event (or not) using the system 104.

The event management system 104 thus receives an event from a managed component of the IT infrastructure 106 (202), and presents the event to the user (204), such as by displaying a GUI dialog window including the event, or in a list of events. When the user performs his or her first action in relation to the event, the event-user interaction monitoring logic 112 determines whether this action is a dismiss action (206)—i.e., whether the user has closed or otherwise dismissed the event, without having taken ownership of the event. If so, then the monitoring logic 112 detects the event as a pre-noise event (208).

However, if the first action is not a dismiss action (206), then this can mean that the user has taken ownership of the event. For instance, when the event is first presented to the user, the user may have one of two options available: take ownership of the event, or close the event. In the former case, if the next action that the user performs is a dismissal of the event (210), and if this second action was performed less than a threshold length of time after the first action was performed (212), then the event-user interaction monitoring logic 112 may consider the second action as an ignore action. Therefore, the event is detected as a pre-noise event (208). Procession from part 206, to part 210, to part 212, and to part 208 can correspond to the user, for instance, taking ownership of the event and then quickly closing the event, which effectively means that the user is ignoring the event even though he or she has taken ownership of the event.

If the next action the user performs is not a dismissal of the event (210) (i.e., the action that the user performs next after having taken ownership of the event), however, then the method 200 is finished (214). This scenario can correspond to the user having taken ownership of the event, and having performed an action (other than closure or other dismissal) to begin resolution of the issue underlying the event. Therefore, the method 200 finishes without detecting the event as a pre-noise event.

However, if the next action the user performs is a dismissal of the event (210) (i.e., the user performs a closure or other dismissal action after having taken ownership of the event), but such dismissal did not occur within the threshold length of time after the user “owned” the event (212), then the method 200 is still finished (214) without detecting the event as a pre-noise event. This scenario can correspond to the user having taken ownership of the event, and then mulling over how to resolve the underlying issue without actually performing any affirmative action to initiate resolution, before deciding to close or otherwise dismiss the event. In this case, the fact that the user waited more than the threshold length of time before he or she dismissed the event is taken to mean that the user did not ignore the event, and therefore the event is not detected as a pre-noise event.

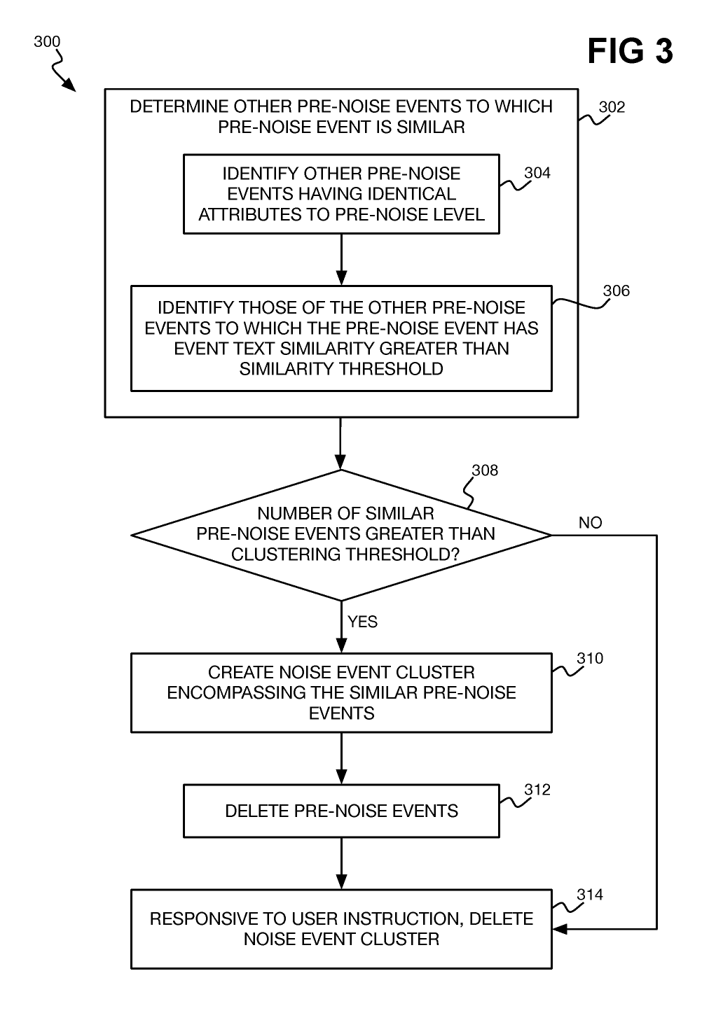

FIG. 3 shows an example method 300 for creating (and deleting) a noise IT event cluster. The noise event cluster generation logic 116 can perform the method 300, responsive to receiving a newly identified pre-noise event from the pre-noise event-user interaction monitoring logic 112. That is, when the monitoring logic 112 detects a pre-noise event, the logic 112 provides the detected pre-noise event to the generation logic 116, which can responsively perform the method 300.

The noise event cluster generation logic 116 determines other pre-noise events previously received from the pre-noise event-user interaction monitoring logic 112 to which the most recently detected and provided pre-noise event (i.e., the current pre-noise event) is similar (302). Such determination can be performed as follows. Of the other pre-noise events that were previously received from the monitoring logic 112, the generation logic 116 can identify those that have identical attributes to the current pre-noise event (304).

For instance, an IT event may have a number of attributes. There may be attributes identifying the particular monitored component of the IT infrastructure 106 at which the event was generated, as well as the priority level of the event, such as critical, high, low, informational, and so on. Other event attributes can include event category, event class, and so on. The noise event cluster generation logic 116 therefore identifies the previously received pre-noise events that have particular attributes (which may be previously specified by the administrator or other user) that are identical to those of the current pre-noise event.

The noise event cluster generation logic 304 then can identify, of the previously received pre-noise events that have identical attributes to the attributes of the current pre-noise event, those events that also have event text similar to the event text of the current pre-noise event greater than a similarity threshold (306). Similarity can thus be considered as being defined with respect to a threshold. The similarity measure may be a cosine distance measure. The similarity threshold may be previously specified by the administrator or other user.

For instance, in addition to having a number of attributes, an IT event may have a more freeform event text field in which the monitored component that generated the event provides information regarding the event. As an example, a monitored component may have issued an event having event type attributes indicating that the event is of an environmental type and is of high priority. The event text of the event may specifically delineate that the monitored environmental temperature exceeds an operating range of the monitored component, and may specify this temperature. Therefore, in part 304, other pre-noise events that have the same attributes (i.e., of environmental type, and of high priority) are identified.

If the number of similar pre-noise events identified in part 302 (i.e., the current pre-noise event and any other pre-noise events to which the current pre-noise event is similar) is greater then a clustering threshold (308), which may be specified by an administrator or other user, then a noise event cluster is created that encompasses these pre-noise events (310). As created, the noise event cluster can include the pre-noise events in question, which are thus promoted to being noise events, and which are then deleted as pre-noise events (312). That is, once a pre-noise event has been included (as a noise event) within a newly created noise event cluster, the pre-noise event can be removed from the list of previously received pre-noise events. Therefore, when another pre-noise event is received and the method 300 performed again, the newly received pre-noise event is not compared to any previously received pre-noise events that have already been included within a created noise event cluster.

As such, if the number of similar pre-noise events identified in part 302 is not greater than the clustering threshold, the noise event cluster generation logic 116 does not create any cluster responsive to receiving the current pre-noise event from the pre-noise event-user interaction monitoring logic 112. However, the current pre-noise event (and any other previously received pre-noise events) is not deleted, but rather is saved or maintained so that when another pre-noise event is subsequently received, the generation logic 116 can again perform the method 300 to again determine whether or not to generate a noise event cluster. Because once a noise event cluster is created those pre-noise events encompassed by the cluster (as newly promoted noise events) are deleted, this means then that each pre-noise event can be encompassed by just one noise event cluster in this implementation.

The noise event cluster generation process of the method 300 that has been outlined does not involve the administrator or any other user. However, the administrator or another user may periodically review the noise event clusters that have been created. As such, responsive to instruction from a user, the noise event cluster generation logic 116 may delete a noise event cluster that it had created (314). The user may also change the conditions governing noise event cluster generation, such as which attributes have to be identical in part 304, the similarity threshold in part 306, and/or the clustering threshold in part 308, to tune the noise event cluster generation process.

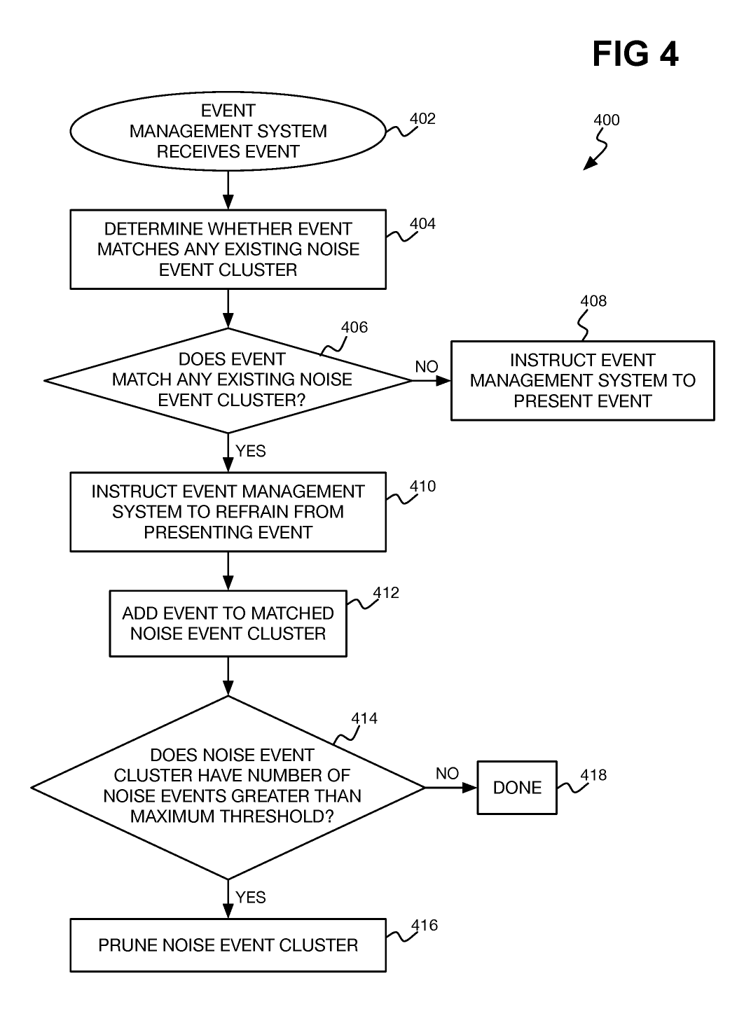

FIG. 4 shows an example method 400 for controlling presentation of an IT event by an event management system, based on whether the event is a noise event. That is, the method 400 determines whether an event management system, like the event management system 104, should be instructed to present an event to an operator or other user, or refrain from presenting the event. The noise event cluster matching logic 126 can perform the method 400, in conjunction with functionality that the event management system 104 performs. The event management system 104 thus receives an event from a managed component of the IT infrastructure 106 (402).

The noise event cluster matching logic 126 determines whether the received event matches any existing noise cluster that may have been created in accordance with the method 300 (404). That is, the matching logic 126 determines whether any noise cluster encompasses the received event. The matching logic 126 may determine a similarity between the received event and a representative event of each noise event cluster in this respect, such that if the determined similarity is greater than a similarity threshold, the received event is said to match the cluster in question. In another implementation, the matching logic determines a similarity between the received event and each event of each noise event cluster. If the determined similarity between the received event of any event or more than a threshold number of events of a given noise event cluster is greater than the similarity threshold, the received event can then be said to match the cluster in question. The similarity determination performed in part 404 between the received event and a representative event (or each event) of a noise event cluster can be achieved as has been described in relation to part 302 of the method 300.

If no existing noise event cluster encompasses the received event (406), then the noise event cluster matching logic 126 instructs the event management system 104 to present the event to the operator or other user for handling (408). The method 400 is thus finished, and thereafter the method 200 may proceed to become operative at part 204, where part 202 of the method 200 and part 402 of the method 400 correspond to one another. That is, whether a received event is a pre-noise event is determined just if it is first determined that the received event does not match any existing noise event cluster.

However, if the received event matches a particular existing noise event cluster (406), then the noise event cluster matching logic 126 instead instructs the event management system 104 to not present the event to the operator or other user (408). The event may instead be logged without first displaying the event to the user in the context of a GUI dialog window, for instance, such as by moving the event to a specific folder without first presenting the event to the user for handling. As another example, the event management system 104 may be instructed to mark the event with a specific flag—such as a flag indicating that the event has been detected as a noise event—without presenting the event to the user. For instance, the event management system 104 may hide or filter those events for which this flag has been set. The received event is thus considered a noise event, and presentation of such noise events is effectively reduced, decreasing the likelihood that the operator will miss a non-noise event due to presentation of such noise events.

The received event is added to the matched noise event cluster (412). As noted above, when a noise event cluster is generated on the basis of more than a clustering threshold number of pre-noise events being similar to one another, the pre-noise events in question become a part of the created cluster, as noise events of the cluster. The received event is similarly added to the event cluster that encompasses the event. The received event becomes a noise event of the noise event cluster in this respect, without having first been detected as a pre-noise event as the events on which basis the cluster was first created were.

Parts 414, 416, and 418 can be performed after the received event has been added to the matched noise event cluster in part 412, or they may be periodically performed in relation to every existing noise event cluster. Over time, a noise event cluster may have a large number of constituent noise events, due to received events being added as noise events to the cluster in part 412 over repeated performance of the method 400. Therefore, if the noise event cluster has more than a maximum threshold number of constituent noise events (414), the cluster may be pruned (416); by comparison, if the cluster has less than this maximum threshold number of constituent events, the method 400 is completed without such pruning occurring (418).

Pruning of a noise event cluster can include removing one or more noise events from the cluster to decrease the size of the cluster. In one implementation, a specified number of noise events—as few as one such event—that are most dissimilar to every other noise event in the cluster are removed. Dissimilarity between two noise events can determined as the inverse of their similarity, where such similarity can be determined as has been described in relation to part 302 of the method 300. Pruning can be achieved in other ways as well. For instance, the oldest event(s) may be removed from a cluster.

The techniques that have been described thus reduce the number of events presented by an event management system to a user like an operator for handling, by suppressing the presentation of events that the user is likely to conclude are noise events. The techniques monitor the user's interaction with events that are presented to determine which events the user considers to be noise events, and then predictively determines subsequently received events as noise events or not. These techniques improve the functioning and capability of the monitored components of the IT infrastructure. This is because the proper performance of the components is more assured, because the likelihood that a user will miss a critical, non-noise event is reduced because the user is not inundated with as many non-critical, noise events.

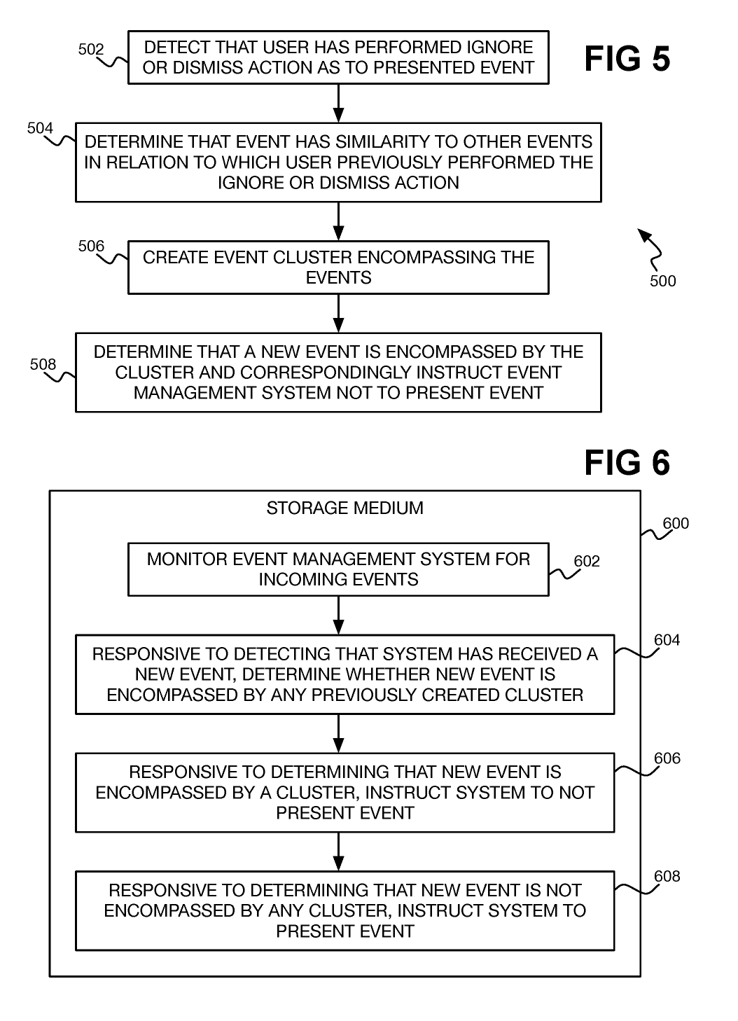

FIGS. 5, 6, and 7 show a method 500, a storage medium 600, and a computing system 700, respectively. The method 500 of FIG. 5 includes steps, parts, or acts 502, 504, 506, and 508, which can be performed by a computing device. The computing device detects that a user has performed an ignore or dismiss action in relation to an IT event that an event management system presented to the user for handling (502). The computing device determines that the event has a similarity to other IT events in relation to which the user performed the ignore or dismiss action (504). The computing device responsively creates an event cluster encompassing these events (506). Responsive to receiving a new event from the event management system, the computing device determines that the new event is encompassed by the event cluster, and correspondingly instructs the event management system to refrain from presenting the new IT event to the user for handling (508).

The storage medium 600 of FIG. 6 can embody or store instructions or program code that when executed by a processor causes steps, parts, or acts 602, 604, 606, and 608 to be performed. The processor monitors an event management system for incoming IT events (602). Responsive to detecting that the event management system has received a new event, the processor determines whether the new event is encompassed by any previously created event cluster (604). Responsive to determining that the new event is encompassed by any previously created event cluster, the processor instructs the event management system to refrain from presenting the new event to a user for handling (606). Responsive to determining that the new event is not encompassed by any previously created event cluster, the processor instructs the event management system to present the new event to the user for handling (608).

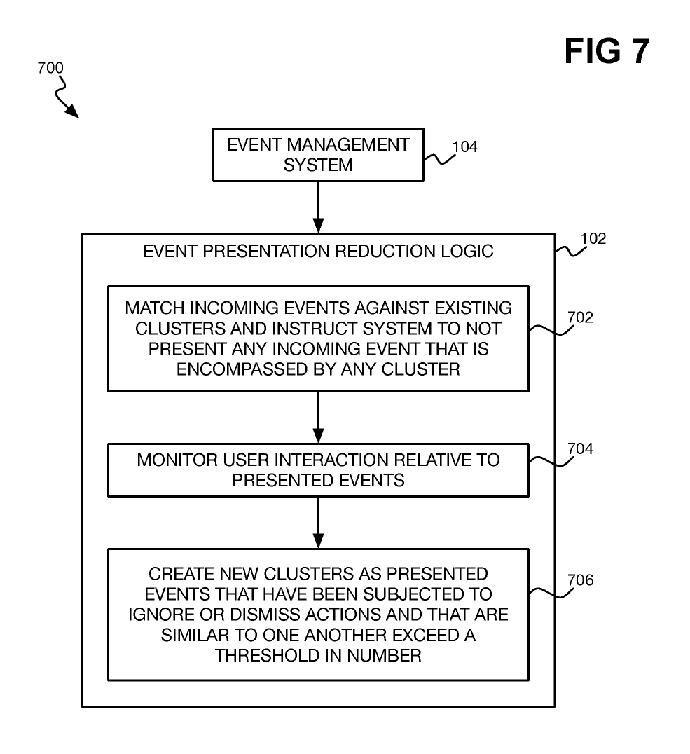

The system 700 of FIG. 7 includes the event presentation reduction logic 102, which is implemented at least in hardware, and the event management system 104, which receives incoming IT events that managed IT components of the IT infrastructure 106 generate for management by a user. The reduction logic 102 matches the incoming events against existing event clusters and instructs the event management system 104 to refrain from presenting to the user any incoming event that any existing event cluster encompasses (702). The logic 102 monitors user interaction relative to presented incoming events for ignore or dismiss action performance (704). The logic 102 creates new event clusters as the presented events that have been subjected to the ignore or dismiss action performance and that are similar to one another exceed a threshold in number (706).

We claim:

1. A method comprising:
detecting, by a computing device, that a user has performed an ignore or dismiss action in relation to an information technology (IT) event that an event management system presented to the user for handling;
determining, by the computing device, that the IT event has a similarity to a plurality of other IT events in relation to which the user performed the ignore or dismiss action;
creating, by the computing device, an event cluster encompassing the other IT events and the IT event to which the other IT events have the similarity; and
responsive to receiving a new IT event from the event management system, determining, by the computing device, that the new IT event is encompassed by the event cluster, and correspondingly instructing the event management system to refrain from presenting the new IT event to the user for handling.

2. The method of claim 1, wherein detecting that the user has performed the ignore or dismiss action comprises:
detecting that the user selected a dismiss option in relation to the IT event as presented by the event management system as a first action that the user has performed in relation to the IT event.

3. The method of claim 1, wherein detecting that the user has performed the ignore or dismiss action comprises:
detecting that the user selected a dismiss option in relation to the IT event as presented by the event management system as a second action that the user has performed in relation to the IT event; and
detecting that the second action was performed within a threshold length of time after the first action was performed.

4. The method of claim 1, wherein determining that the IT event has the similarity to the other IT events comprises:
determining that the IT event has a selected plurality of attributes identical to corresponding attributes of the other IT events; and
determining that the IT event has event text similar to corresponding event text of the other IT events.

5. The method of claim 1, wherein the computing device creates the event cluster responsive to determining that a sum of a number of the other IT events and the IT event to which the other IT events have the similarity is greater than a threshold.

6. The method of claim 1, wherein instructing the event management system to refrain presenting the new IT event to the user for handling for handling comprises:
instructing the event management system to move the new IT event to a specific folder without first presenting the new IT event to the user for handling.

7. The method of claim 1, wherein instructing the event management system to refrain presenting the new IT event to the user for handling for handling comprises:
instructing the event management system to mark the new IT event with a specific flag without first presenting the new IT event to the user for handling.

8. The method of claim 1, further comprising, responsive to determining that the new IT event is encompassed by the event cluster:
adding, by the computing device, the new IT event to the event cluster; and
in response to determining that a number of constituent IT events of the event cluster is greater than a threshold, removing the constituent IT event that is least similar to other of the constituent IT events.

9. The method of claim 1, further comprising:
deleting, by the computing device, the event cluster at behest of an administrator user other than the user.

10. The method of claim 1, further comprising:
performing a remediation action to resolve an issue that resulted in generation of the new IT event.

11. A non-transitory computer-readable data storage medium storing instructions executable by a processor to:
monitor an event management system for incoming information technology (IT) events;
responsive to detecting that the event management system has received a new IT event, determine whether the new IT event is encompassed by any previously created event cluster;
responsive to determining that the new IT event is encompassed by any previously created event cluster, instruct the event management system to refrain from presenting the new IT event to a user for handling; and
responsive to determining that the new IT event is not encompassed by any previously created event cluster, instruct the event management system to present the new IT event to the user for handling.

12. The non-transitory computer-readable data storage medium of claim 11, wherein the instructions are executable by the processor to further, after instructing the event management system to present the new IT event to the user for handling:
responsive to detecting that the user has performed an ignore or dismiss action in relation to the new IT event upon presentation of the new IT event to the user by the event management system for handling, determine that the new IT event has a similarity to a plurality of other IT events in relation to which the user performed the ignore or dismiss action; and
responsive to determining that the new IT event has the similarity to the other IT events in relation to which the user performed the ignore or dismiss action, create a new event cluster against which subsequently received IT events are compared.

13. The non-transitory computer-readable data storage medium of claim 12, wherein the instructions are executable by the processor to determine that the new IT event has the similarity to the other IT events by:
determining that the new IT event has a selected plurality of attributes identical to corresponding attributes of the other IT events; and
determining that the new IT event has event text similar to corresponding event text of the other IT events.

14. The non-transitory computer-readable data storage medium of claim 11, wherein the instructions are executable by the processor to further, responsive to determining that the new IT event is encompassed by any event cluster:
adding the new IT event to an event cluster encompassing the new IT event; and
periodically prune the event cluster once the event cluster encompasses more than a threshold number of constituent IT events.

15. A system comprising:
an event management system that receives incoming information technology (IT) events that managed IT components generate for management by a user; and
event presentation reduction logic implemented at least in hardware to:
match the incoming IT events against existing event clusters and instruct the event management system to refrain from presenting to the user any incoming IT event that any existing event cluster encompasses;
monitor user interaction relative to presented incoming IT events for ignore or dismiss action performance;
create new event clusters as the presented IT events that have been subjected to the ignore or dismiss action performance and that are similar to one another exceed a threshold in number.

16. The system of claim 15, wherein the event presentation reduction logic is to instruct the event management system to present to the user any incoming IT event that no existing event cluster encompasses.

17. The system of claim 15, wherein the event presentation reduction logic is to determine that a first presented IT event is similar to a second presented IT event by determining that each of the first and second presented IT events has selected identical attributes and has event text similar to one another.

18. The system of claim 15, wherein the event presentation reduction logic is to further add to the existing event clusters the incoming IT events that the event management system has been instructed to refrain from presenting.

19. The system of claim 18, wherein the event presentation reduction logic is to further periodically prune the existing event clusters as the existing event clusters have more than a threshold number of constituent IT events.

20. The system of claim 19, wherein the event presentation reduction logic is to periodically prune the existing event clusters by removing therefrom the constituent IT events that are most dissimilar.
